(19) United States
(12) Patent Application Publication
(10) Pub. No.: US 2015/0189022 A1
(43) Pub. Date: Jul. 2, 2015

(54) INFORMATION PROCESSING APPARATUS

(71) Applicant: Panasonic Intellectual Property Management Co., Ltd., Osaka (JP)

(72) Inventors: Ryuichi OKAMOTO, Osaka (JP); Masaki MUKAI, Hyogo (JP); Tomoyuki SHIMOMURA, Osaka (JP); Masaichi YANO, Hyogo (JP)

(21) Appl. No.: 14/551,896

(22) Filed: Nov. 24, 2014

(30) Foreign Application Priority Data
Dec. 27, 2013 (JP) 2013-271259
Sep. 26, 2014 (JP) 2014-196558

(51) Int. Cl. H04L 29/08; G06F 1/32

(52) U.S. Cl. CPC H04L 67/141; G06F 1/3296

(57) ABSTRACT

An information processing apparatus of the present disclosure includes: an input unit configured to receive an instruction from a user; a communication unit configured to perform a connection to a network; a storage unit configured to store a profile and an OS; and a processor configured to control the input unit, the communication unit, and the storage unit. The profile includes identification information that identifies the network, and attribute information that indicates an attribute inherent in the network, the OS has at least two states which are a sleep state and a non-sleep state, and in a case where the processor controls the communication unit to establish the connection to the network, which is identified by the identification information of the profile, when the OS is in the sleep state, the processor establishes a connection to a network in which the instruction from the user is not required for the input unit, and does not establish a connection to a network in which the instruction from the user is required for the input unit.

### BACKGROUND OF THE INVENTION

1. Field of the Invention

The present disclosure relates to an information processing apparatus having a network connection function.

2. Description of the Related Art

PTL 1 discloses an information processing apparatus that attempts to connect to a plurality of networks in accordance with a priority order.

### CITATION LIST

### Patent Literature

PTL 1: Japanese Translation of PCT Publication No. 2008-520164

### SUMMARY OF THE INVENTION

The present disclosure provides an information processing apparatus capable of appropriately managing a network connection.

An information processing apparatus of the present disclosure includes: an input unit configured to receive an instruction from a user; a communication unit configured to perform a connection to a network; a storage unit configured to store a profile and an OS; and a processor configured to control the input unit, the communication unit, and the storage unit, wherein the profile includes identification information that identifies the network, and attribute information that indicates an attribute inherent in the network, the OS has at least two states which are a sleep state and a non-sleep state, and in a case where the processor controls the communication unit to establish the connection to the network, which is identified by the identification information of the profile, when the OS is in the sleep state, the processor establishes a connection to a network in which the instruction from the user is not required for the input unit, and does not establish a connection to a network in which the instruction from the user is required for the input unit.

The information processing apparatus of the present disclosure is capable of appropriately managing the network connection.

### BRIEF DESCRIPTION OF THE DRAWINGS

FIG. 1 is a view showing an environment where an information processing apparatus in an exemplary embodiment operates;

FIG. 2 is an exterior view of the information processing apparatus in the exemplary embodiment;

FIG. 3 is a block diagram of the information processing apparatus in the exemplary embodiment;

FIG. 4 is a view showing an example of a profile stored in a storage unit of the information processing apparatus in the exemplary embodiment;

FIG. 5 is a flowchart showing an operation performed by the information processing apparatus in the exemplary embodiment;

FIG. 6 is a view showing a table for determining whether or not an input from a user to an input unit is necessary in order to establish a connection to a network in the information processing apparatus in the exemplary embodiment; and

FIG. 7 is a flowchart showing another operation performed by the information processing apparatus in the exemplary embodiment.

### DETAILED DESCRIPTION OF THE PREFERRED EMBODIMENT

A description is made below in detail of an exemplary embodiment with reference to the drawings as appropriate. However, a description in more detail than necessary may be omitted. For example, a detailed description of a well-known matter and a duplicate description of substantially the same configuration may be omitted. These omissions are made in order to avoid unnecessary redundancy of the following description and to facilitate the understanding of those skilled in the art.

Note that the accompanying drawings and the following description are provided in order to allow those skilled in the art to fully understand the present disclosure, and it is not intended to thereby limit the subject matter described in the scope of claims.

### Exemplary Embodiment

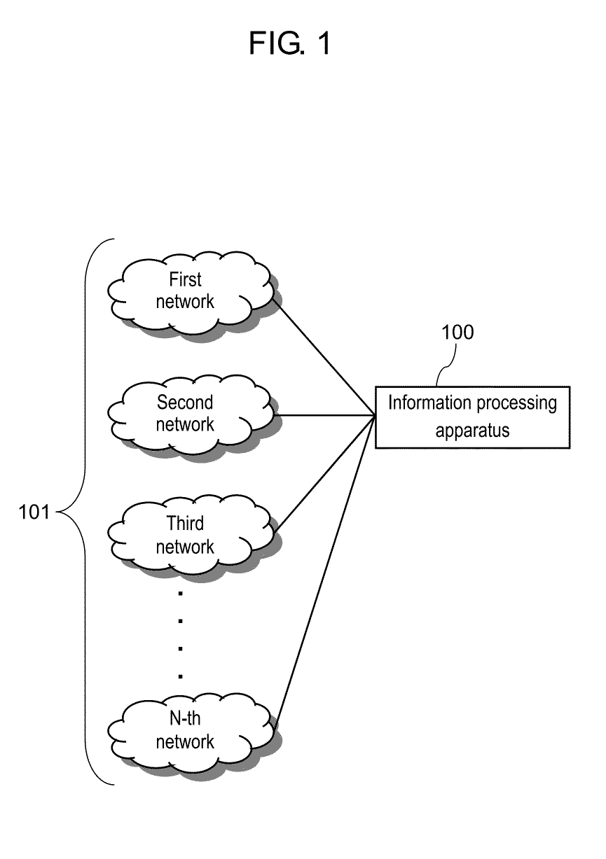

A description is made below of the exemplary embodiment with reference to FIGS. 1 to 7.

### [1-1-1. Configuration of System]

FIG. 1 is a view showing an environment where information processing apparatus 100 in the exemplary embodiment operates. In FIG. 1, information processing apparatus 100 performs an operation in an environment where network 101 including one or more networks is present.

Network 101 is a network to which information processing apparatus 100 is connectable. Network 101 includes a variety of known networks. For example, network 101 includes a WWAN (Wireless Wide Area Network) which is a communication service for allowing information processing apparatus 100 to connect to a wide area data communication network by wireless communication, a WLAN (Wireless Local Area Network/Wireless LAN) which is a local area communication network for wirelessly transmitting and receiving data, a WiMAX (registered trademark) (Worldwide Interoperability for Microwave Access) network which is one of the standards of the radio communication technology, and a wired LAN (Local Area Network) which is a local area communication network which connects devices to one another by communication cables such as copper fibers and optical fibers and allows the devices to communicate with one another by transmission/reception of electricity or light.

### [1-1-2. Configuration of Information Processing Apparatus]

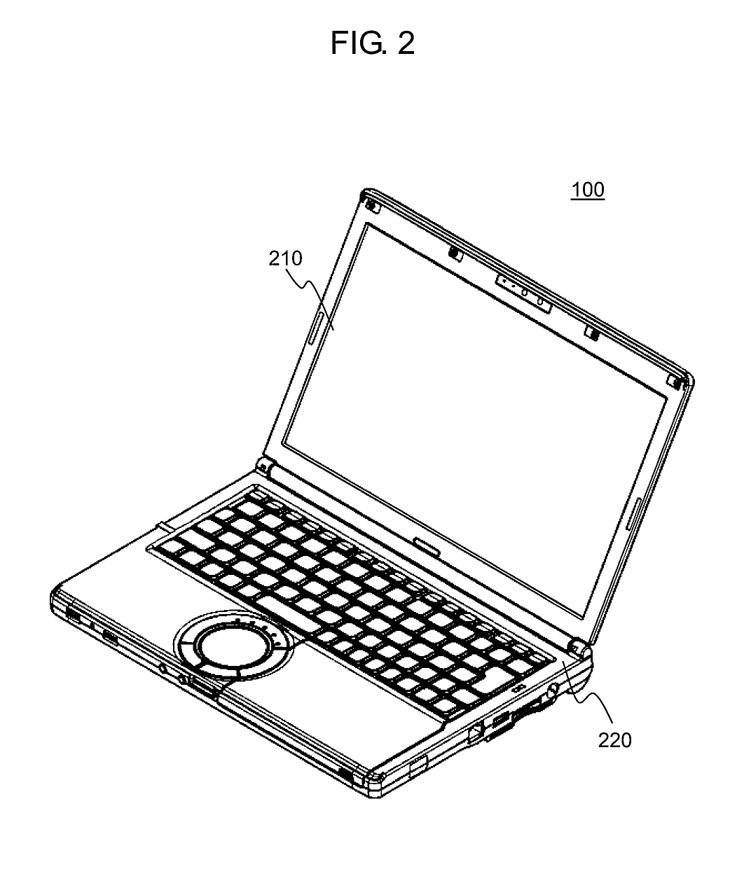

FIG. 2 is an exterior view of information processing apparatus 100 in the exemplary embodiment.

Information processing apparatus 100 performs predetermined information processing based on an OS (Operating System). The description of this exemplary embodiment is made by using a notebook computer as an example of information processing apparatus 100.

Note that information processing apparatus 100 of the present disclosure is not limited to the notebook computer. A laptop PC, a tablet PC, a smart phone, a wearable computer or the like is applicable as information processing apparatus 100.

Output unit 210 displays an image and video. Typically, a liquid crystal display is used as output unit 210.

Input unit 220 receives an input. Typically, a touch panel, a keyboard, a touch pad, buttons and the like are used as input unit 220.

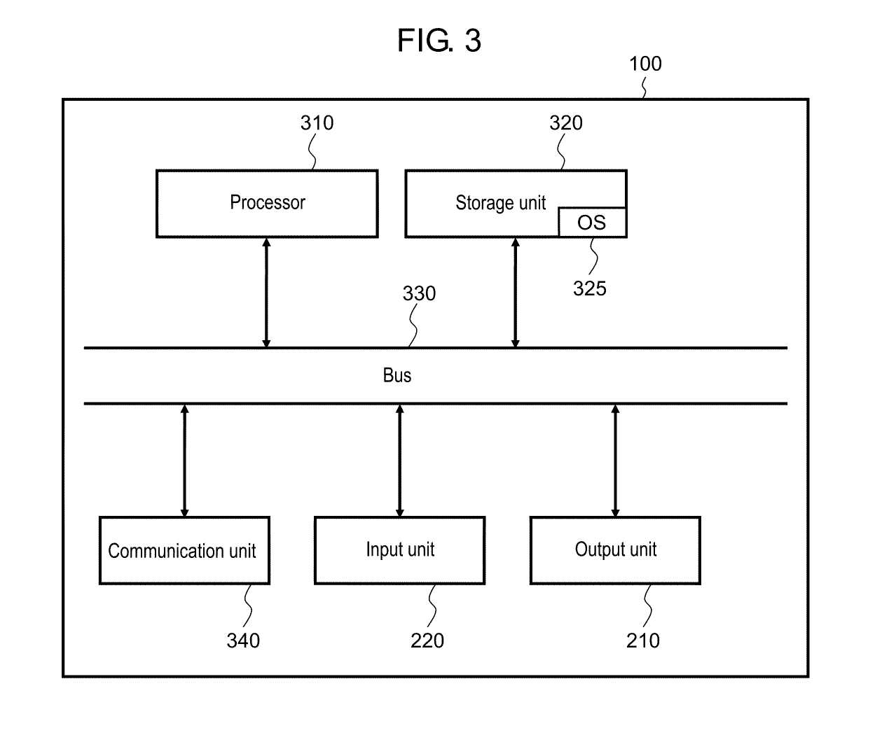

FIG. 3 is a block diagram of information processing apparatus 100 in the exemplary embodiment.

Processor 310 executes a program, and thereby controls other components of information processing apparatus 100. For example, processor 310 controls communication unit 340 to implement a connection to network 101.

Storage unit 320 temporarily or permanently stores data necessary for the processing of information processing apparatus 100. For example, storage unit 320 stores OS 325, the program, a profile to be described later, and the like. A volatile memory, a non-volatile memory, an HDD (Hard Disk Drive) or the like is used as storage unit 320.

OS 325 is software that controls the operation of information processing apparatus 100. In this exemplary embodiment, OS 325 causes OS 325 itself to transition between at least two states, a sleep state and a non-sleep state. For example, in a case where input unit 220 has not received an input from a user for a while, OS 325 causes itself to transition to the sleep state. The sleep state is a state in which OS 325 causes itself to transition, anticipating that use of information processing apparatus 100 is suspended, or a state in which OS 325 causes itself to transition under an instruction from the user of information processing apparatus 100. The sleep state is a state in which the operation of information processing apparatus 100 is temporary stopped, and information processing apparatus 100 is put on standby in a power saving mode. The sleep state includes a hibernation state in which contents of a memory are stored in a hard disk and a power supply is turned off, a standby state in which power supply to the hard disk or the like is stopped while the memory is kept operating for setting information processing apparatus 100 to a power saving mode, and a screen-off state in which display of input unit 220 is stopped. Information indicating whether or not OS 325 is currently in the sleep state is stored in a predetermined region of storage unit 320.

Bus 330 is a portion through which electrical signals transmitted and received by other components of information processing apparatus 100 pass. Through bus 330, a control signal and data are transmitted and received between the respective components of information processing apparatus 100.

Communication unit 340 is controlled by processor 310 to attempt the connection to network 101, establish the connection thereto, and disconnect the connection thereto. Here, the attempt of the connection means that processor 310 performs communication with a gateway, which is defined for network 101, through communication unit 340 in order to establish the connection with network 101. The establishment of the connection refers to a state in which a terminal present in network 101 and information processing apparatus 100 become communicable with each other through the above-mentioned attempt of the connection. Moreover, communication unit 340 detects a communication card and a network cable, which are connected to information processing apparatus 100, and detects radio waves of WWAN and WLAN, which are present in a space, and thereby specifies a network to which information processing apparatus 100 is connectable. Communication unit 340 notifies processor 310 of the network to which information processing apparatus 100 is connectable, the network being specified by information processing apparatus 100.

Note that communication unit 340 may be single, or may be plural according to types of the respective networks. For example, such a plurality of communication units include a communication unit for WWAN, a communication unit for WLAN, a communication unit for WiMAX, and a communication unit for wired LAN, for example.

Note that the above-mentioned respective components may constitute information processing apparatus 100 in a physically independent state, or may constitute information processing apparatus 100 while being partially integrated. For example, functions of processor 310, a storage unit 320, and communication unit 340 are partly or entirely integrated and mounted within one LSI (Large Scale Integration).

Moreover, other physically independent components may be combined with the above-mentioned respective components in order to constitute the above-mentioned respective components. For example, a plurality of physically different storage units may be used in order to constitute logically single storage unit 320.

Moreover, in order to distribute a load on processor 310, a plurality of processors and microcomputers mounted within communication unit 340 and storage unit 320 may perform actual processing. In this exemplary embodiment, components which perform these pieces of processing are generically defined as processor 310.

### [1-1-3. Configuration of Profile]

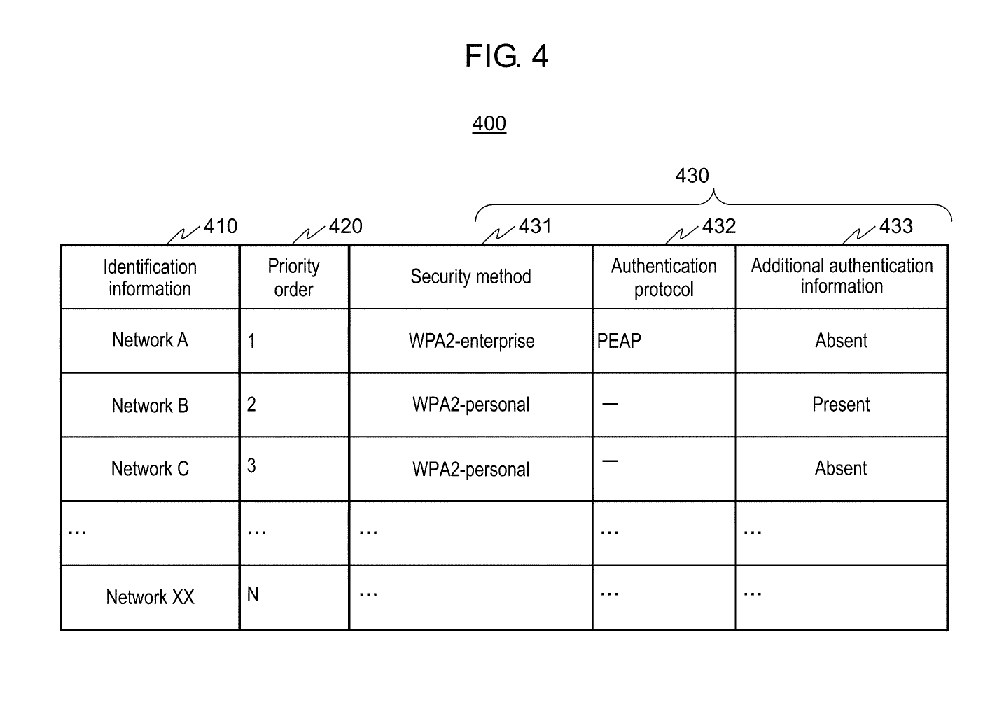

FIG. 4 is a view showing an example of a profile stored in storage unit 320 of information processing apparatus 100 in the exemplary embodiment. Profile 400 is information in a database format. In profile 400, one or more sets of identification information 410, and priority order 420 and attribute information 430 which correspond thereto are stored.

Identification information 410 is information that identifies network 101 to which information processing apparatus 100 connects. Identification information 410 is information that specifies types of network, for example, such as “WLAN”, “WiMAX”, “WWAN”, and “wired LAN”. Identification information 410 is not limited to the information that specifies the above-mentioned types of network. Identification information 410 may include information that identifies an SSID as an identifier of an access point in the wireless LAN, and that identifies a service provider of WiMAX or WWAN, which is a connection destination. Moreover, identification information 410 may be a name arbitrarily given to a specific network by a user. That is, identification information 410 only needs to be capable of specifying a connection destination.

Priority order 420 is information that indicates an order of performing the connection to network 101. For example, when information processing apparatus 100 is connectable to both of network A and network B, processor 310 refers to priority order 420 and causes communication unit 340 to attempt the connection to a network which is higher in priority order 420. In this exemplary embodiment, as a value of priority order 420 is smaller, an order thereof is higher. Hence, when information processing apparatus 100 is connectable to both of network A and network B, processor 310 causes communication unit 340 to attempt the connection to network A. In this exemplary embodiment, processor 310 specifies whether or not such a network, to which information processing apparatus 100 is connectable, is present at a predetermined interval for example, every few seconds to every few milliseconds. In a case where a plurality of networks, to which information processing apparatus 100 is connectable, is present, processor causes communication unit 340 to attempt the connection to the networks in accordance with priority order 420.

Attribute information 430 is information that indicates an attribute inherent in network 101. Attribute information 430 includes security method 431, authentication protocol 432, and additional authentication information 433.

Security method 431 is information that indicates a method of security, which is used when information processing apparatus 100 connects to network 101. Examples of security method 431 include WPA (W-Fi Protected Access)2-Enterprise and WPA2-Personal, which perform encryption of Wireless LAN. A description is made of a different point between WPA2-Enterprise and WPA2-Personal. In WPA2-Enterprise, in order to establish the connection to network 101, information processing apparatus 100 performs authentication with an external server, for example, a server using protocol of RADIUS (Remote Authentication Dial In User Service), and meanwhile, in WPA2-Personal, information processing apparatus 100 does not perform the authentication with the server in order to establish the connection to network 101. In a case where the authentication with the external server is required, it is necessary for the user to input a user ID and a password to input unit 220.

Authentication protocol 432 is information that indicates protocol when information processing apparatus 100 connects to network 101. Examples of authentication protocol 432 include EAP-MD5 (Extensible Authentication Protocol Message Digest Algorithm 5), EAP-TLS (Transport Layer Security), and PEAP (Protected Extensible Authentication Protocol).

Additional authentication information 433 is information that indicates whether or not additional authentication is required when information processing apparatus 100 connects to network 101. In this exemplary embodiment, a case where the additional authentication is required is a case where an input from input unit 220 is required in order to establish a connection communicably to a wider network included in network 101 after establishing a connection to in a part of network included therein. Examples of the network for which the additional authentication is required include a hot spot in a VPN (Virtual Private Network) and Public Wireless LAN service. When processor 310 controls communication unit 340 to attempt a connection to the hot spot, such a connection in the restricted network included in network 101 is established. In a case where it is necessary to access an Internet site of WWW (World Wide Web) or the like through the hot spot, the user inputs the user name and the password through input unit 220 to the external server present in the restricted network included in network 101.

Contents of profile 400 of FIG. 4 are sequentially listed below. In a case where identification information 410 is “Network A”, priority order 420 is “1”, security method 431 is “WPA2-Enterprise”, authentication protocol 432 is “PERP”, and additional authentication information 433 is “absent”. In a case where identification information 410 is “Network B”, priority order 420 is “2”, security method 431 is “WPA2-Personal”, authentication protocol 432 is “absent”, and additional authentication information 433 is “present”. In a case where identification information 410 is “Network C”, priority order 420 is “3”, security method 431 is “WPA2-Personal”, authentication protocol 432 is “absent”, and additional authentication information 433 is “absent”. After “Network C”, profile 400 is set to “Network XX” in identification information 410.

Note that attribute information 430 described above may be preset by the user, or may be generated from information obtained in such a manner that communication unit 340 detects a radio wave of WWAN and WLAN, which is present in the space, and decodes the detected radio wave.

### [1-2. Operation]

A description is made of the operation of information processing apparatus 100 configured as described above.

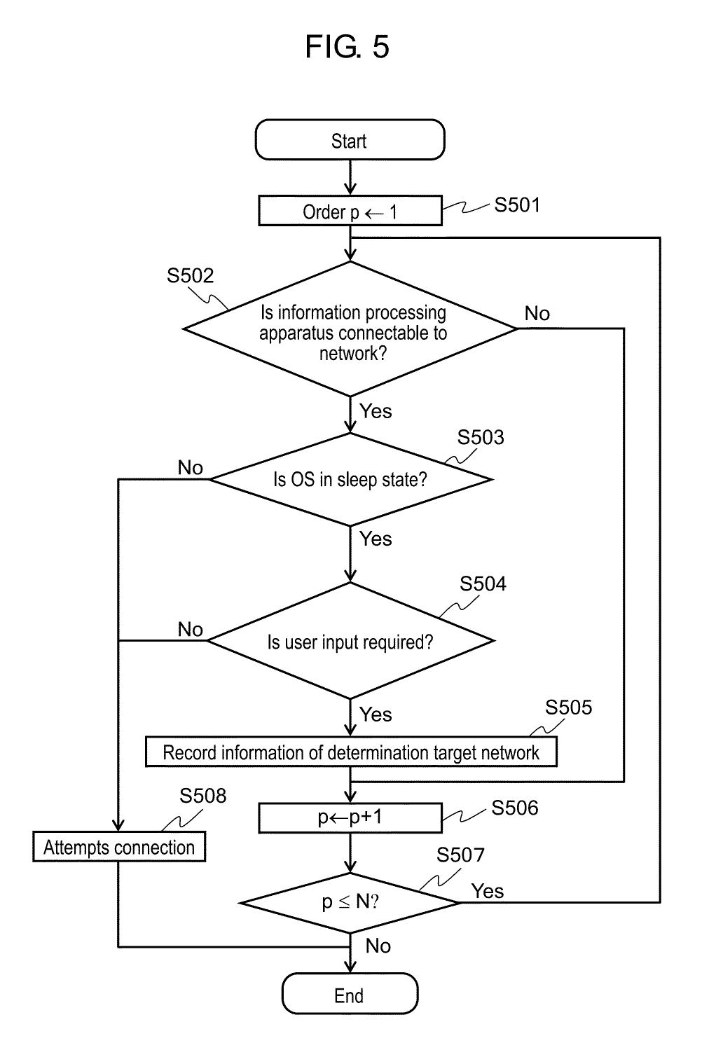

FIG. 5 is a flowchart showing the operation performed by information processing apparatus 100 in the exemplary embodiment.

Processor 310 attempts and determines the connection to the network, which is indicated by identification information 410, through communication unit 340 in accordance with priority order 420.

(Step S501) Order p of the connection to network 101 is set to “1” of priority order 420.

(Step S502) Processor 310 confirms whether or not information processing apparatus 100 is connectable to the network included in network 101, which has identification information 410 with respect to order p. For example, in a case where order p is “1”, identification information 410 is “Network A”. Processor 310 confirms whether or not information processing apparatus 100 is connectable to the network, which is included in network 101, by controlling communication unit 340. Here, the network included in network 101, to which processor 310 confirms whether or not information processing apparatus 100 is connectable, is described as “determination target network” by distinguishing the network concerned from other networks included in network 101. When information processing apparatus 100 is connectable to determination target network (when Yes), processor 310 proceeds to Step S503. When information processing apparatus 100 is not connectable to determination target network (when No), processor 310 proceeds to Step S506.

(Step S503) Processor 310 confirms whether or not OS 325 is in the sleep state. Specifically, processor 310 determines whether or not OS 325 is in the sleep state with reference to a predetermined region of storage unit 320. When OS 325 is in the sleep state (when Yes), processor 310 proceeds to Step S504. When OS 325 is not in the sleep state (when No), processor 310 proceeds to Step S508.

(Step S504) By using attribute information 430, processor 310 determines whether or not the input to input unit 220 by the user, that is, a user input is required in order to establish the connection to the determination target network. Specifically, by using attribute information 430, processor 310 makes the above determination by using a table for determining whether or not the user input is required.

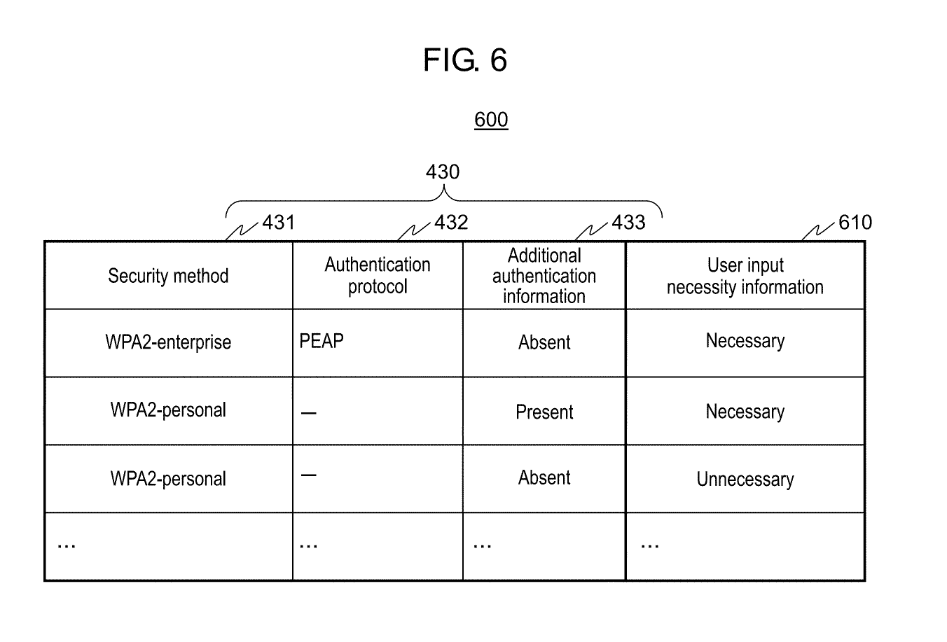

FIG. 6 is a view showing table 600 for determining whether or not the user input is required in order to establish the connection to network 101 in information processing apparatus 100 in the exemplary embodiment. Table 600 is stored in storage unit 320. In Table 600, attribute information 430 and user input necessity information 610 are described in association with each other.

With regard to user input necessity information 610, either “necessity” or “nonnecessity” is set. By using attribute information 430 of the determination target network, processor 310 determines whether or not the user input is required by referring to corresponding user input necessity information 610 in table 600.

Note that user input necessity information 610 may be individually set and described in table 600 in advance by the user for each piece of attribute information 430, or may be automatically described in table 600 according to a predetermined algorithm. Here, an example of the predetermined algorithm is an algorithm in which security method 431 in attribute information 430 requires server authentication. Alternatively, there is an algorithm which sets user input necessity information 610 to “necessity” in a case where additional authentication information 433 in attribute information 430 is “present”, and sets “nonnecessity” otherwise.

When processor 310 determines that the user input is not required (when No), processor 310 proceeds to Step S508. When processor 310 determines that the user input is required (when Yes), processor 310 proceeds to Step S505.

(Step S505) Processor 310 records information of the determination target network in storage unit 320.

(Step S506) Processor 310 adds 1 to order p, to obtain new order p.

(Step S507) Processor 310 confirms whether or not order p is priority order 420 “N (N is a natural number)” or less. When order p is priority order 420 “N” or less (when Yes), processor 310 proceeds to Step S502. When order p is larger than priority order 420 “N” (when No), processor 310 ends the processing.

(Step S508) Processor 310 controls communication unit 340 to attempt the connection to the determination target network.

Information processing apparatus 100 in this exemplary embodiment executes other processing simultaneously with the processing of the flowchart in FIG. 5.

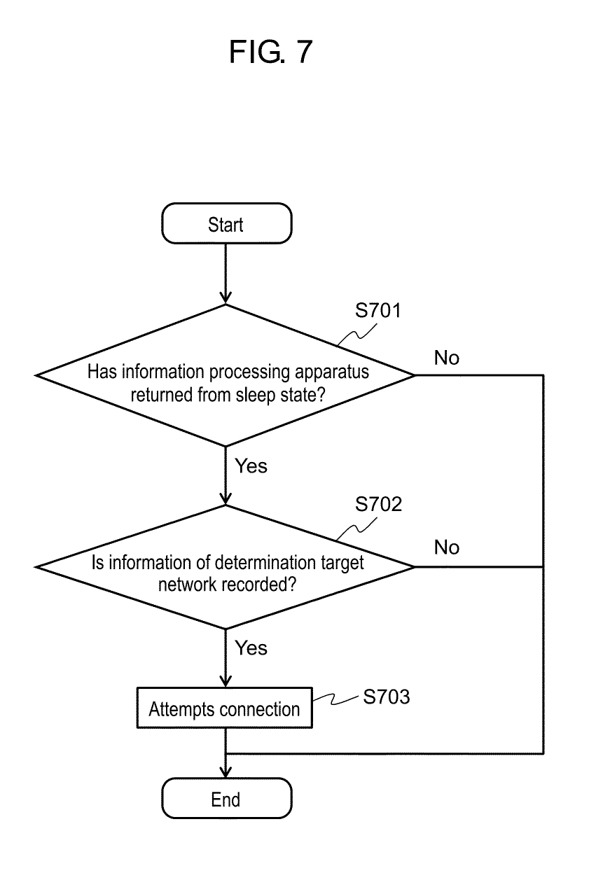

FIG. 7 is a flowchart showing another operation performed by information processing apparatus 100 in the exemplary embodiment.

The flowchart of FIG. 7 is periodically executed by processor 310 while information processing apparatus 100 is operating.

(Step S701) Processor 310 confirms whether or not information processing apparatus 100 has returned from the sleep state. When information processing apparatus 100 has returned from the sleep state (when Yes), processor 310 proceeds to Step S702. When information processing apparatus 100 has not returned from the sleep sate (when No), processor 310 ends the processing.

(Step S702) Processor 310 confirms whether or not the information of the determination target network of Step S505 is recorded. When the information is recorded (when Yes), processor proceeds to Step S703. When the information is not recorded (when No), processor ends the processing.

(Step S703) Processor 310 controls communication unit 340 to attempt the connection to network 101 by using the information of the determination target network, which is recorded in storage unit 320.

Note that, in Step S703, through output unit 210, processor 310 may notify the user that there is a network included in network 101, to which processor 310 does not control communication unit 340 to connect at the time of the sleep state. For example, processor 310 may notify the user of a message such as “There is a network for which the connection is skipped at the sleep time”.

Moreover, in Step S703, processor 310 may notify the user whether or not to connect to the network included in network 101, to which processor 310 has not controlled communication unit 340 to connect at the time of the sleep state. For example, processor 310 may notify the user of a message such as “Do you like to connect to the skipped network?”. Then, processor 310 may control communication unit 340 to attempt the connection to the skipped network, which is included in network 101, based on a response from the user.

Moreover, in Step S703, processor 310 may determine whether or not the information of the determination target network, which is recorded in storage unit 320, is higher in priority order 420 than the information of the network included in network 101, to which processor 310 controls communication unit 340 to connect at the present point of time. Then, in a case where the information of the determination target network is higher in priority order 420, processor 310 may control communication unit 340 to attempt the connection to network 101.

### [1-3. Effects and the Like]

As described above, the information processing apparatus of the present disclosure includes: the input unit configured to receive the instruction from the user; the communication unit configured to perform the connection to the network; the storage unit configured to store the profile and the OS; and the processor configured to control the input unit, the communication unit, and the storage unit. The profile includes the identification information that identifies the network, and the attribute information that indicates the attribute inherent in the network, the OS has at least two states which are the sleep state and the non-sleep state. In the case where the processor controls the communication unit to establish the connection to the network, which is identified by the identification information of the profile, when the OS is in the sleep state, the processor establishes the connection to the network in which the instruction from the user is not required for the input unit, and does not establish the connection to a network in which the instruction from the user is required for the input unit.

In this way, at the time of establishing the connection, information processing apparatus 100 in which OS 325 is in the sleep state does not connect to the network included in network 101, which requires the user input. Accordingly, a useless attempt of the connection can be suppressed. As a result, information processing apparatus 100 of the present disclosure can appropriately manage the network connection.

Moreover, in information processing apparatus 100 of the present disclosure, the profile includes the priority order of the connection to the network, and the processor attempts the connection to the network based on the priority order when the OS is in the sleep state. In this way, if the user input is not required in the network in which the priority order is low, information processing apparatus 100 in which the OS 325 is in the sleep state attempts the connection thereto. Information processing apparatus 100 can connect to the network even if OS 325 is in the sleep state, and accordingly, information processing apparatus 100 can receive mail and receive an event, which is caused by a network application, even if OS 325 is in the sleep state.

Moreover, in information processing apparatus 100 of the present disclosure, the profile includes the security method for use in establishing the connection to the network, and in the case where the processor controls the communication unit to establish the connection to the network, which is identified by the identification information of the profile, when the OS is in the sleep state, the processor determines whether or not the instruction from the user is required for the input unit by using the security method.

In this way, by using the security method, it can be determined whether or not the user input is required. Hence, a necessity to prepare a complicated algorithm in order to determine whether or not the user input is required is reduced.

Moreover, in information processing apparatus 100 of the present disclosure, the profile includes the additional authentication information that indicates whether or not the additional authentication is required in order to establish the connection communicably to the wider network after establishing the connection in a part of a network included in the network. In the case where the processor controls the communication unit to establish the connection to the network, which is identified by the identification information of the profile, when the OS is in the sleep state, the processor determines whether or not the instruction from the user is required for the input unit by using the additional authentication information.

In this way, there is reduced a possibility that information processing apparatus 100 in which OS 325 is in the sleep state may establish the connection to the network only in the limited range and that information processing apparatus 100 may be inhibited from connecting to the other network.

Moreover, information processing apparatus 100 of the present disclosure further includes the output unit. In the case where the processor controls the communication unit to establish the connection to the network, which is identified by the identification information of the profile, when the OS is in the sleep state, the processor stores, in the storage unit, the information of the network in which the instruction from the user is required for the input unit. Then, when the state of the OS moves from the sleep state to the non-sleep state, the processor notifies the output unit that the network is not connected, the network in which the instruction from the user is required for the input unit and of which information is stored in the storage unit.

In this way, in a case where the user input is enabled when the state of OS 325 moves from the sleep state to the non-sleep state, the user can be prompted to connect to the network for which the user input is required.

Moreover, in information processing apparatus 100 of the present disclosure, in the case where the processor controls the communication unit to establish the connection to the network, which is identified by the identification information of the profile, when the OS is in the sleep state, the processor stores, in the storage unit, the information of the network in which the instruction from the user is required for the input unit. Then, when the state of the OS moves from the sleep state to the non-sleep state, the processor connects to the network in which the instruction from the user is required for the input unit and of which information is stored in the storage unit.

In this way, in the case where the connection to the network in which the priority order is high is skipped, the connection to this network can be established.

Note that, in this exemplary embodiment, whether or not to execute the predetermined program is determined based on whether or not information processing apparatus 100 is in the sleep state. However, whether or not to execute the predetermined program may be determined based on whether or not OS 325 is in a system lock state that is a state before the user logs into OS 325.

What is claimed is:

1. An information processing apparatus comprising:
an input unit configured to receive an instruction from a user;
a communication unit configured to perform a connection to a network;
a storage unit configured to store a profile and an OS; and
a processor configured to control the input unit, the communication unit, and the storage unit,
wherein the profile includes identification information that identifies the network, and attribute information that indicates an attribute inherent in the network,
the OS has at least two states which are a sleep state and a non-sleep state, and
in a case where the processor controls the communication unit to establish the connection to the network, which is identified by the identification information of the profile, when the OS is in the sleep state,
the processor establishes a connection to a network in which the instruction from the user is not required for the input unit, and does not establish a connection to a network in which the instruction from the user is required for the input unit.

2. The information processing apparatus according to claim 1, wherein
the profile includes a priority order of the connection to the network, and
the processor attempts to connect to the network based on the priority order when the OS is in the sleep state.

3. The information processing apparatus according to claim 1, wherein
the profile includes a security method used in establishing the connection to the network,
and in a case where the processor controls the communication unit to establish the connection to the network, which is identified by the identification information of the profile, when the OS is in the sleep state,
the processor determines whether or not the instruction from the user is required for the input unit by using the security method.

4. The information processing apparatus according to claim 1, wherein
the profile includes additional authentication information that indicates whether or not it is necessary to perform additional authentication in order to establish a connection communicably to a wider network after establishing the connection in a part of a network included in the network, and
in a case where the processor controls the communication unit to establish the connection to the network, which is identified by the identification information of the profile, when the OS is in the sleep state, the processor determines whether or not the instruction from the user is required for the input unit by using the additional authentication information.

5. The information processing apparatus according to claim 1, further comprising an output unit,
wherein, in the case where the processor controls the communication unit to establish the connection to the network, which is identified by the identification information of the profile, when the OS is in the sleep state, the processor stores, in the storage unit, information of the network in which the instruction from the user is required for the input unit, and
when the state of the OS moves from the sleep state to the non-sleep state, the processor notifies the output unit that the network is not connected, the network in which the instruction from the user is required for the input unit and of which information is stored in the storage unit.

6. The information processing apparatus according to claim 1, wherein
in the case where the processor controls the communication unit to establish the connection to the network, which is identified by the identification information of the profile, when the OS is in the sleep state, the processor stores, in the storage unit, information of the network in which the instruction from the user is required for the input unit, and
when the state of the OS moves from the sleep state to the non-sleep state, the processor connects to the network in which the instruction from the user is required for the input unit and of which information is stored in the storage unit.
